(19) United States
(12) Patent Application Publication
(10) Pub. No.: US 2024/0426104 A1
(43) Pub. Date: Dec. 26, 2024

(54) A TRUSS

(71) Applicant: Framecad Licensing Limited, Auckland (NZ)

(72) Inventors: Daniel Jerry SPENCER, Auckland (NZ); Stewart Mark TAYLOR, Auckland (NZ)

(21) Appl. No.: 18/684,827

(22) PCT Filed: Aug. 16, 2022
(86) PCT No.: PCT/NZ2022/050105

§ 371 Date: Feb. 19, 2024

(30) Foreign Application Priority Data
Aug. 17, 2021 (AU) 2021218024

(51) Int. Cl. E04C 3/09; E04C 3/04

(52) U.S. Cl. CPC E04C 3/09; E04C 2003/0413; E04C 2003/0473

(57) ABSTRACT

A truss, comprising: a first truss member; a second truss member; and a third truss member configured to join the first truss member to the second truss member; wherein the third truss member comprises an end portion comprising: a flat base; an arm; and a shoulder raised relative to the base between the base and the arm; wherein the shoulder is substantially parallel to the base.

### FIELD

This relates to a truss.

### BACKGROUND

A truss is an assembly of truss members (chords/webs) that creates a rigid structure. Multiple truss members are connected at nodes to form a truss. In civil engineering, trusses are commonly used in roofs, floors, bridges and towers.

### SUMMARY

In a first example embodiment, there is provided a truss, comprising: a first truss member; a second truss member; and a third truss member configured to join the first truss member to the second truss member; wherein the third truss member comprises an end portion comprising: a flat base; an arm; and a shoulder raised relative to the base between the base and the arm; wherein the shoulder is substantially parallel to the base.

In a second example embodiment, there is provided a method for manufacturing a truss member, comprising: cutting a sheet of steel in a first direction at a first position; cutting the sheet of steel in a second direction that is substantially perpendicular to the first direction; cutting the sheet of steel in a third direction that is substantially parallel to the first direction at a second position different from the first position; rolling forming the sheet of metal into a substantially C-channel frame; and reducing a width of an end portion of the steel frame, the width being a lateral dimension.

A method for manufacturing a truss member, comprising: cutting an end portion of a steel frame along its height at a first longitudinal position; cutting the end portion of the steel frame along its length to a second longitudinal position; cutting the end portion of the steel frame along its height at the second longitudinal position; and reducing a width of the end portion of the steel frame, the width being a lateral dimension.

### BRIEF DESCRIPTION

The description is framed by way of example with reference to the drawings which show certain embodiments. However, these drawings are provided for illustration only, and do not exhaustively set out all embodiments.

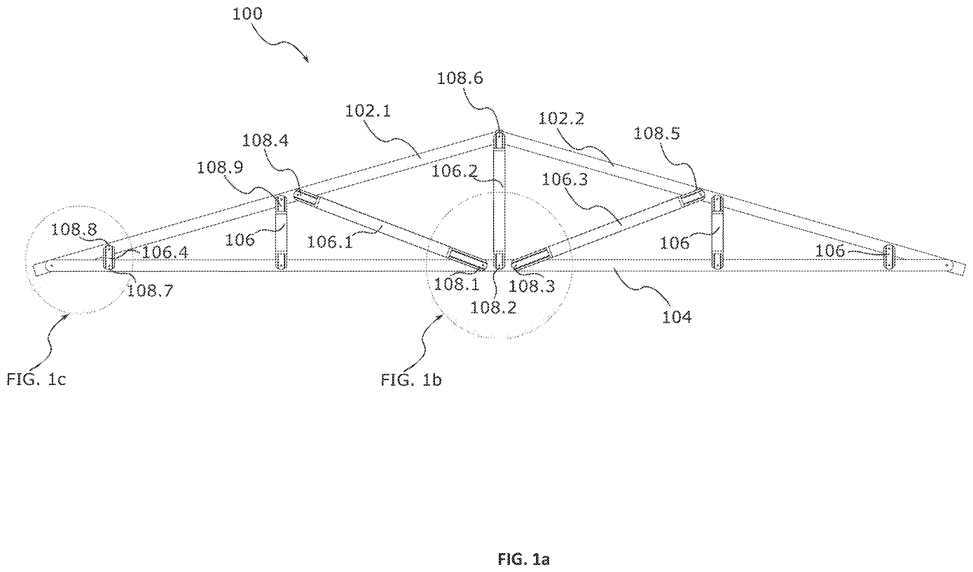

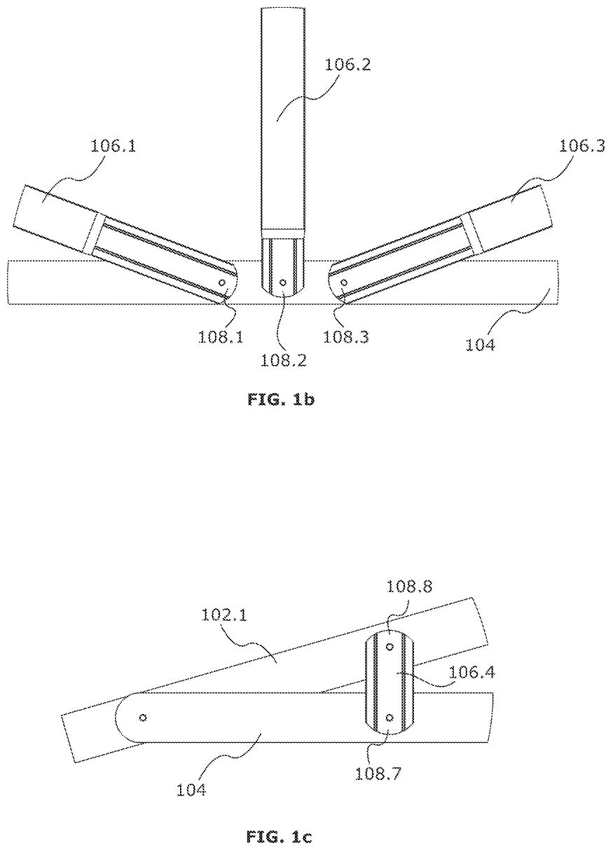

FIG. 1a shows a truss according to one example embodiment.

FIG. 1b shows a connection in the truss of FIG. 1a.

FIG. 1c shows another connection in the truss of FIG. 1a.

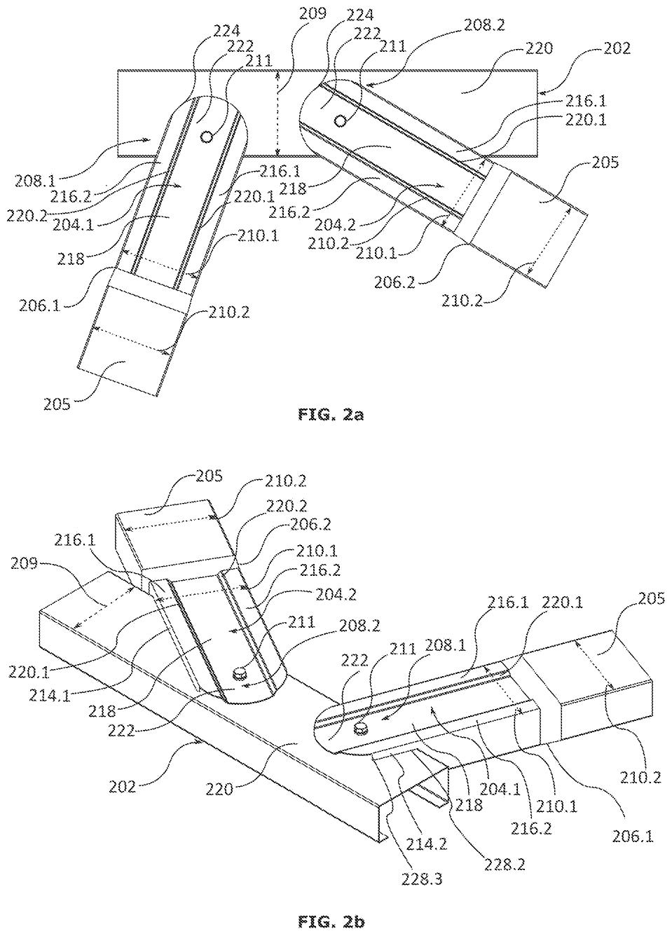

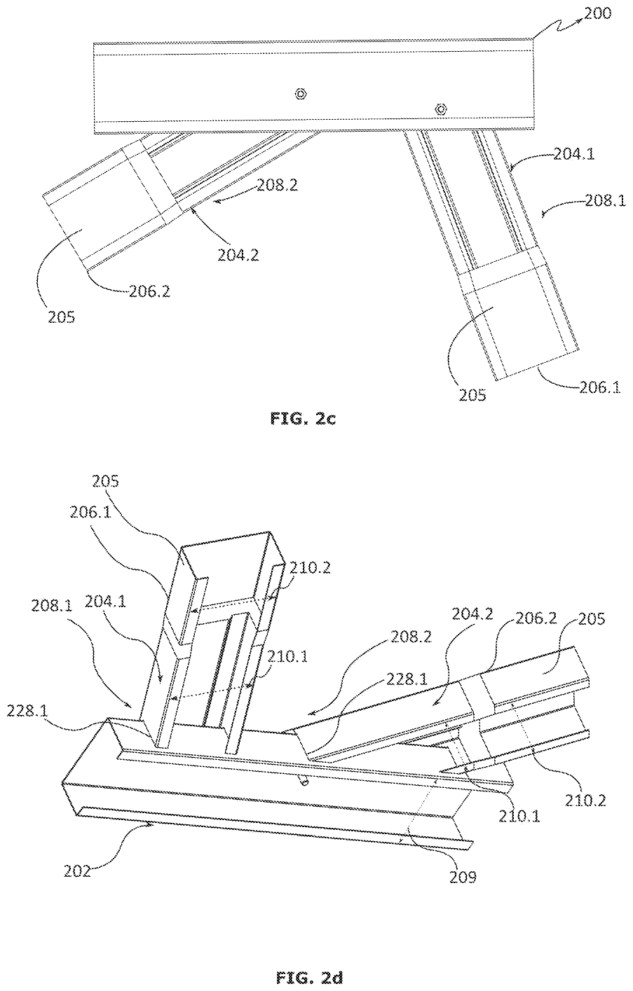

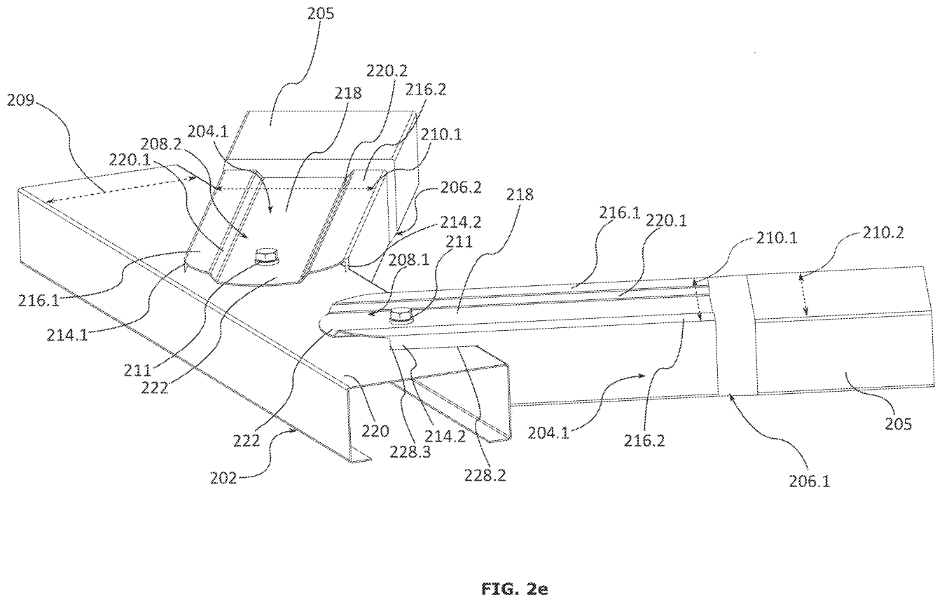

FIG. 2a is a top view of a connection in a truss.

FIG. 2b is a perspective view of the connection of FIG. 2a.

FIG. 2c is a bottom view of the connection of FIG. 2a.

FIG. 2d is another perspective view of the connection of FIG. 2a.

FIG. 2e is yet another perspective view of the connection of FIG. 2a.

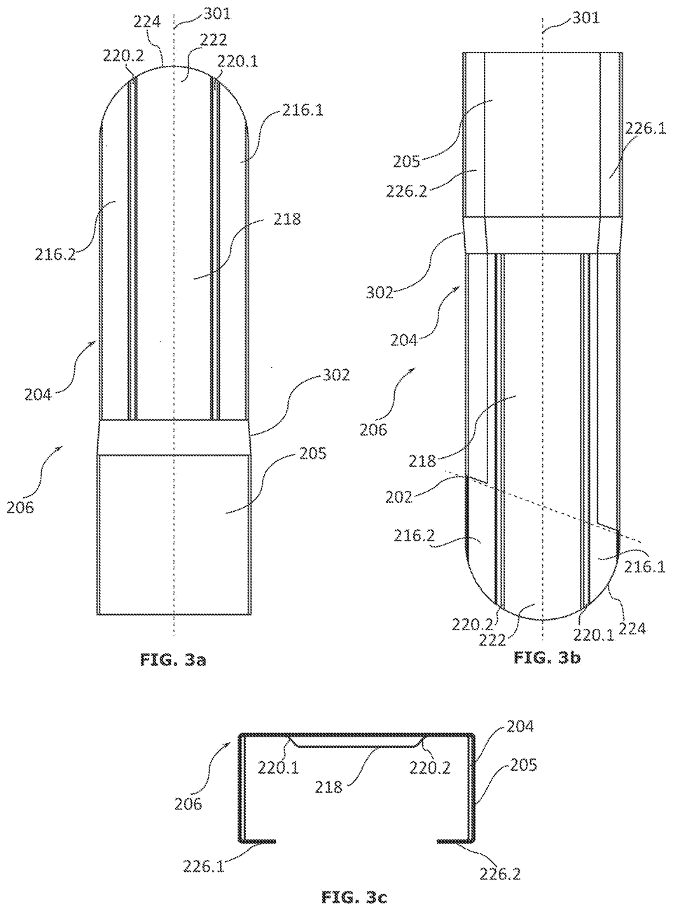

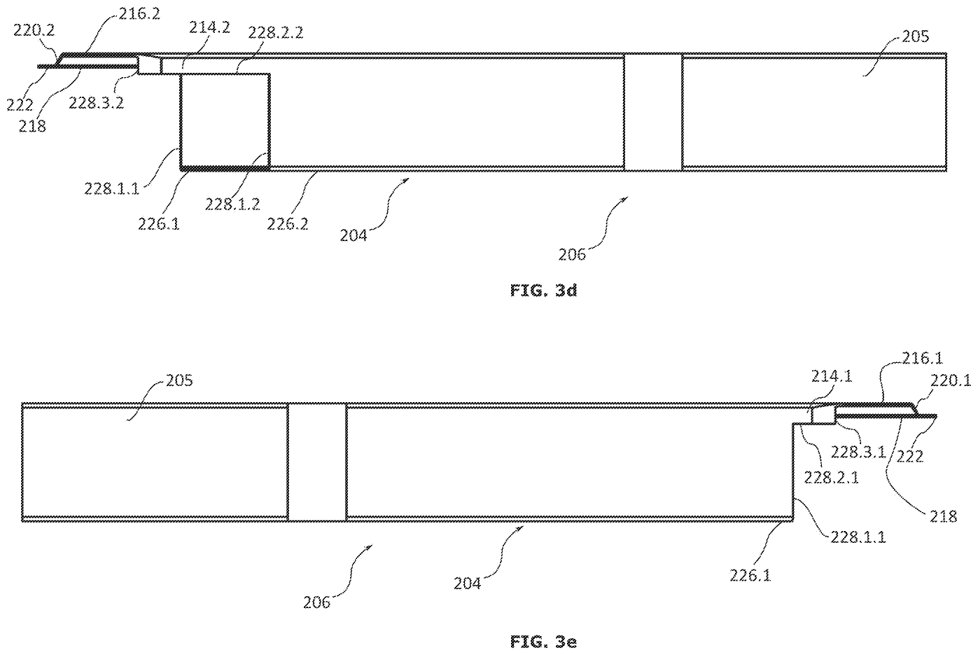

FIG. 3a is a top view of a section of a joining member according to one example embodiment.

FIG. 3b is a bottom view of the joining member section of FIG. 3a.

FIG. 3c is the front and back view of the joining member section of FIG. 3a.

FIG. 3d is a first side view of the joining member section of FIG. 3a.

FIG. 3e is a second side view of the joining member section of FIG. 3a.

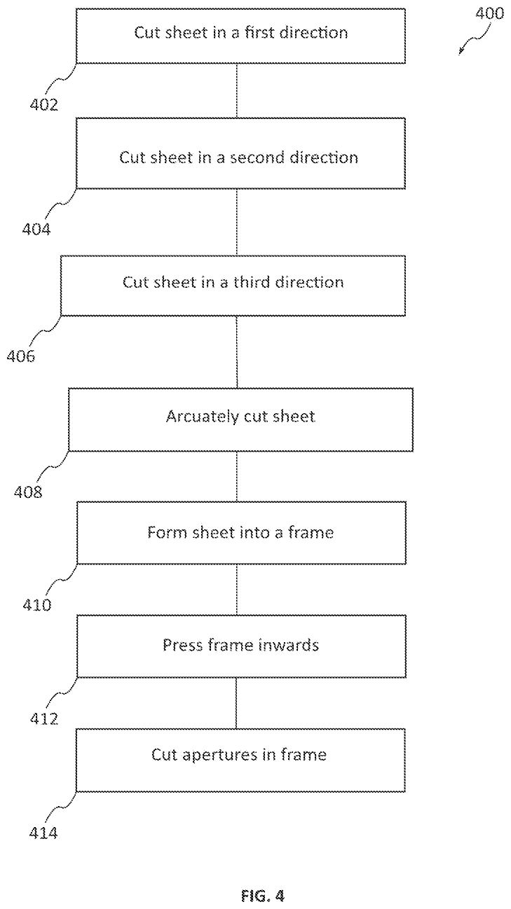

FIG. 4 is an example method for forming a truss joining member.

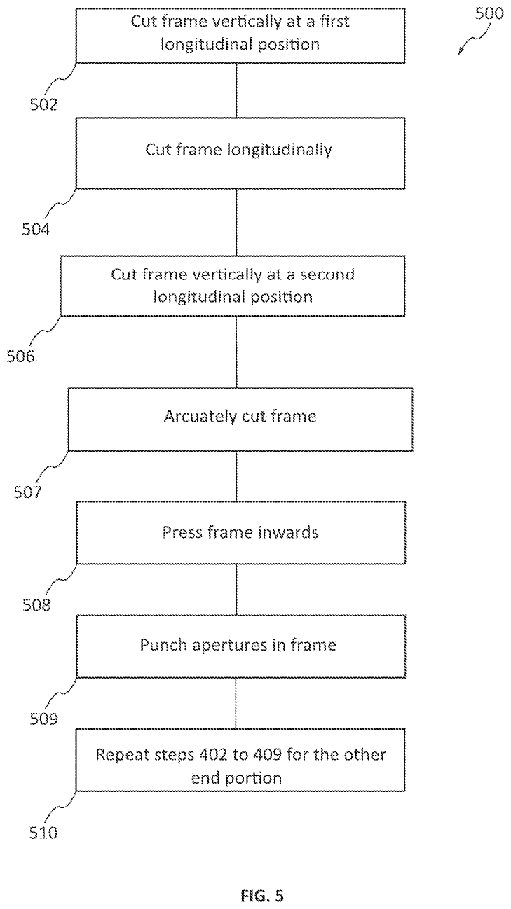

FIG. 5 is another example method for forming a truss joining member.

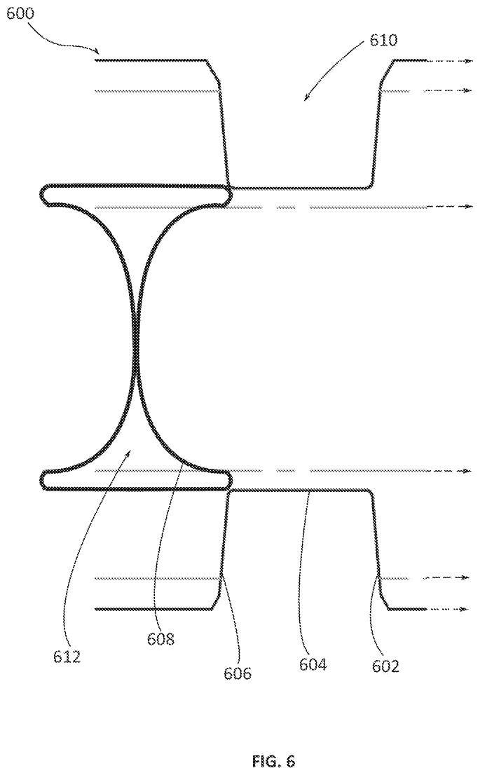

FIG. 6 shows an example method for forming edges of a truss joining member.

### DETAILED DESCRIPTION

A truss is described herein which comprises a plurality of truss members. Some of the truss members join other truss members to one another. These joining members comprise end portions comprising a flat base, two arms, and two shoulders. Preferably, all truss members are manufactured using the same type of material metal, which may be a steel.

Truss

FIGS. 1a, 1b, and 1c show an example truss according to one example embodiment of the invention.

The truss 100 comprises a plurality of truss members comprising two top chords 102, a bottom chord 104, and seven webs 106 interconnected as shown in FIG. 1a. In particular, the webs 106 are joining members as they join the top chords 102 to the bottom chord 104. A web 106 may comprise two end portions joined by a middle portion, each end portion forming a connection with a top chord 102, a bottom chord 104, or both.

FIG. 1b shows connections 108.1, 108.2, and 108.3 in the truss 100 in more detail. At the connections 108.1, 108.2, and 108.3, three central webs 106.1, 106.2, and 106.3 respectively adjoin a central portion of the bottom chord 104. The end portion of each of the central webs 106.1, 106.2, and 106.3 is shown in a planar view. The end portion of one web 106 may be substantially structurally similar to the end portion of another web 106. However, the exact dimensions may differ depending on the function of a particular web 106. For example, the end portion of the central web 106.2 is substantially shorter than the end portion of the central webs 106.1 and 106.3. Nevertheless, the end portions of the central webs 106.1, 106.2, and 106.3 are still substantially similar in the sense that they share key structural features. The structure of the end portion of a web 106 and the connection thereof are described in more detail below.

The central web 106.1 connects the bottom chord 104 to the top chord 102.1 via its middle portion at a connection 108.4. Similarly, the central web 106.3 connects the bottom chord 104 to the top chord 102.2 via its middle portion at a connection 108.5. Similarly, the central web 106.2 connects the bottom chord 104 to the top chord 102.2 as well as the top chord 102.1 at a connection 108.6.

FIG. 1c shows connections 108.7 and 108.8 in the truss 100 in more detail. At the connection 108.7, a side web 106.4 adjoins the bottom chord 104. At the connection 108.8, the side web 106.4 adjoins the top chord 102.1. Since the separation between the top chord 102.1 and the bottom chord 104 is sufficiently small, the side web 106.4 does not comprise a middle portion. That is, not every web 106 requires a middle portion with two end portions: the length of each portion may be adjusted to suit the function of a particular web 106, and the middle portion may be omitted entirely as shown in FIG. 1c.

Any one of a top chord 102, a bottom chord 104, and a web 106 may be formed using a C-channel or preferably U-channel steel frames. The type of steel may be cold-formed steel (CFS) or light gauge steel (LGS). There are apertures on the steel frames for receiving fasteners. An example method for manufacturing a web 106 is described in more detail below. The gauge of the C-channel steel frame may range from 0.4 mm to 3.2 mm.

### Joining Member

FIGS. 2a, 2b, 2c, 2d, and 2e show two connections 208.1 and 208.2 between two joining members 206.1 and 206.2 and another truss member 202, respectively. These connections 208.1 and 208.2 may be the connections 108.4 and 108.9 of the truss 100. The truss member 202 may be a top chord (e.g. 102.1 or 102.2) or a bottom chord (e.g. 104).

As can be seen from FIGS. 2a to 2e, an end portion 204.1 of the joining member 206.1 is structurally similar to an end portion 204.2 of the joining member 206.2. Any reference to a feature of one joining member does not limit the description to that particular joining member. References may be made to multiple joining members for convenience when describing the structure of the joining members.

The end portion 204 has a reduced width 210.1 compared to the width 210.2 of the middle portion 205 of the joining member 206. Similarly, the end portion 204 may have a reduced height 212.1 compared to the height 212.2 of the middle portion 205. These reductions in width and height may be achieved as part of a steel pressing, stamping, swaging, folding, or rolling. The reduction in width may be about twice the gauge of C-channel steel frame. These reductions may be caused by the end portion being pressed inwards. In an example embodiment where the end portion has a continuously rolled profile, both the width and the height are reduced.

Structurally, the end portion 204 comprises a first arm 214.1 and a first shoulder 216.1 on one side of the end portion 204 and a second arm 214.2 and a second shoulder 216.2 on the opposing side of the end portion 204. A base 218 is disposed between the first shoulder 216.1 (and the first arm 214.1) and the second shoulder 216.2 (and the second arm 214.2). A first wall 220.1 adjoins the base 218 and the first shoulder 216.1. A second wall 220.2 adjoins the base 218 and the second shoulder 216.2.

The base 218 may be substantially flat. The underside of the base 218 engages substantially flush with a top surface 220 of the truss member 202. Preferably, the base 218 provides a large contact surface for engagement with the top surface 220 of the truss member 202. Having a sufficiently large contact surface may improve the robustness of the connection between a joining member and a truss member, meaning a truss member or a joining member may be less likely to snap or deform near a connection under stress. In one example embodiment, the width of the base 218 is at least 50% of the width 209 of the truss member 202. In one example embodiment, the length of the contact surface is at least 50% of the width 209 of the truss member 202, the length being the length of the longest line segment enclosed by the contact surface area. In one example embodiment, the contact surface area is at least 50%. In one example embodiment, the base 218 is pressed inwards to a depth relative to an outer surface of the middle portion, the depth being less than or equal to the height of the arms 214.1 and 214.2.

A fastener 211 (e.g. a bolt or a screw) passes through aligned apertures in the base 218 and the top surface 220 of the truss member 202, which achieves the connection. While only one fastener 211 is shown per end portion 204, multiple fasteners 211 may be provided in other embodiments.

The shoulders 216.1 and 216.2 are raised relative to the base 218 and may be substantially parallel to the base 218. The shoulders 216.1 and 216.2 may each have an arcuate edge that forms part of an arc 224 in the top view of FIG. 2a.

The walls 220.1 and 220.2 are shown to be at an approximately 45° angle relative to the base 218 in FIGS. 2a to 2e, but the walls 220.1 and 220.2 may adjoin the base 218 and the shoulders 216.1 and 216.2 at a different angle. It may be preferable that the angle be between 30 to 90 degrees, preferably as near to 90 degrees as possible.

Further, the walls 220.1 and 220.2 need not be straight. Each of the walls 220.1 and 220.2 may comprise multiple sections connected in a piecewise manner. Irrespective of the shape of the walls 220.1 and 220.2, they define a height difference between the base 218 and the shoulders 216.1 and 216.2. This height difference is preferably substantially similar to the height of the arms 214.1 and 214.2 such that the shoulders 216.1 and 216.2 are substantially parallel to the base 218.

The arms 214.1 and 214.2 may be substantially perpendicular to the base 218. The arms 214.1 and 214.2 also abut the top surface 220 of the truss member 202 but provide a substantially smaller contact surface compared to the base 218. The arms 214.1 and 214.2 may have different lengths depending on the function of the particular joining member. As an example, the arm 214.1 of the joining member 206.2 is substantially longer than the arm 214.2 of the joining member 206.2 because of the angle at which the joining member 206.2 adjoins the truss member 202. In contrast, the arms 214.1 and 214.2 may have substantially the same lengths for the connections 108.2 and 108.6 in the truss 100. While the arms 214.1 and 214.2 may be different lengths, they are substantially aligned at the end proximate the rounded tip portion 222. The length of an arm 214 is preferably at least 50% of the width 209 of the truss member 202.

The provision of the arms 214 may improve the robustness of the connection between a joining member and a truss member, meaning a truss member or a joining member may be less likely to snap or deform near a connection under stress.

The end portion 204 may comprise a rounded tip portion 222 defined by the arc 224 when viewed from the top. The length of the rounded tip portion 22, that is, the longitudinal (lengthwise) separation between the arms 214.1 and 214.2 and the apex of the rounded tip portion 222 is preferably at least 20% of the width 209 of the truss member 202. In absolute terms, the length of the rounded tip portion may be no less than 20 mm.

As can be seen most clearly in FIG. 2d, the joining member 206 is substantially hollow and has a profile that is substantially a C-channel section. The end portion 204 comprises additional cut-outs near the rounded tip portion 222, defined by a cutting edge 228.1, another cutting edge 228.2, and a further cutting edge 228.3. The cutting edges 228.1 and 228.2 form a cut-out to allow the end portion 204 to partially receive and enclose the truss member 202. The cutting edges 228.2 and 228.3 form the arm 214. The cutting edges 228.1 and 228.3 may be substantially parallel to each other; the cutting edge 228.2 may be substantially perpendicular to the cutting edges 228.1 and 228.3.

FIGS. 3a, 3b, 3c, 3d and 3e show the end portion 204 of the joining member 206 in isolation.

When viewed from the top (FIG. 3a), the end portion 204 is substantially symmetrical about a longitudinal axis 301 (parallel to length). The reduction in width can be seen at 302.

When viewed from the bottom (FIG. 3b), the end portion 204 is substantially asymmetrical about the longitudinal axis 301 since tab 226.2 is shorter than tab 226.1. The asymmetry is due to the positioning of the joining member 206 in a truss: the joining member 206 adjoins a truss member 202 at a substantially non-perpendicular angle. That is, an edge (dashed line 202) of the truss member 202 is not perpendicular to the longitudinal axis 301. For example, joining member 206.2 of FIGS. 2a to 2e is such a joining member 206. In contrast, a joining member 206 such as the joining member 108.2 or the joining member 108.6 may be substantially symmetrical about a longitudinal axis even when viewed from the bottom.

FIG. 3c clearly shows the C-channel profile of the joining member 206.

FIGS. 3d and 3e are side views of the joining member 206. In this particular case, the side views are different because the joining member 206 adjoins a truss member 202 at a substantially non-perpendicular angle as explained above.

FIGS. 3d and 3e show different cutting edges 228.

In FIG. 3d, two vertical cutting edges 228.1.1 and 228.1.2 are visible. The cutting edge 228.1.2 corresponds to the shorter tab 226.2, and the cutting edge 228.1.1 corresponds to the longer tab 226.1. Consequently, the cutting edge 228.1.1 is closer to the rounded tip portion 222 than the cutting edge 228.1.2. For the same reason, the cutting edge 228.2.2 is longer than the cutting edge 228.2.1, and the former obscures the latter in FIG. 3d. In other words, the arm 214.1 is longer than the arm 214.2 in this example embodiment. Both the cutting edge 228.3.1 and the cutting edge 228.3.2 have the same longitudinal position, but only the cutting edge 228.3.2 is visible since the cutting edge 228.3.1 is obscured.

If the joining member 206 were for a connection such as the connection 108.2 or the connection 108.6, however, then only one set of cutting edges 228.1, 228.2 and 228.3 would be visible in either side view.

In FIG. 3e, the longer side of the end portion 204 is closer to the viewer, so the only visible cutting edges are 228.1.1, 228.2.1, and 228.3.1. The cutting edges on the shorter side of the end portion 204, that is, cutting edges 228.1.2, 228.2.2 and 228.3.2, are obscured by the longer side of the end portion 204 and the arm 214.1.

The joining member 206 and the truss member 202 are preferably formed using C-channel or U-channel steel frames. The type of steel may be cold-formed steel (CFS) or light gauge steel (LGS). An example method for manufacturing a web 106 is described in more detail below. The gauge of the C-channel or U-channel steel frame may range from 0.4 mm to 3.2 mm.

### Manufacturing

### Method 1

FIG. 4 describes a method 400 for manufacturing a joining member. Method 400 assumes a flat sheet of steel as the starting point. The type of steel may be cold-formed steel (CFS) or light gauge steel (LGS).

Method 400 may be more efficient than method 500 (described below) in mass production of joining members.

At step 402, the sheet of metal is cut in a first direction. This cutting edge may become the cutting edge 228.1 or the cutting edge 228.3 once a joining member is formed. Referring to a flat sheet of metal 600 depicted in FIG. 6, this cutting edge may be the edge 602.

At step 404, the sheet of metal is cut in a second direction different from the first direction. The second direction may be substantially perpendicular to the first direction. This cutting edge may become the cutting edge 228.2 once a joining member is formed. Referring to a flat sheet of metal 600 depicted in FIG. 6, this cutting edge may be the edge 604.

At step 406, the sheet of metal is cut in a third direction. The third direction may be substantially parallel to the first direction. This cutting edge may become the cutting edge 228.1 or the cutting edge 228.3 once a joining member is formed. If the cutting edge of step 502 is 228.1, then this cutting edge will be 228.3. If the cutting edge of step 502 is 228.3, then this cutting edge will be 228.1. Referring to a flat sheet of metal 600 depicted in FIG. 6, this cutting edge may be the edge 606.

Optionally at step 408, the sheet of metal is cut to from a curved edge. This curved edge may become the arc 224 of the rounded tip portion 222 once a joining member is formed. Referring to a flat sheet of metal 600 depicted in FIG. 6, this cutting edge may be the edge 608.

The cutting steps 402, 404 and 406 may need to be repeated so that the resultant joining member may have four sets of cutting edges 228.1, 228.2 and 228.3, that is, one set of cutting edges on each side of each end portion of the joining member. The cutting step 408 may need to be repeated so that the resultant joining member may have more than one rounded tip portions 222.

Cutting may comprise stamping, punching, and blanking. Each cutting edge need not be formed separately. For example, edges 602, 604, 606, and 608 may be cut using two tools each having a preconfigured profile. Edges 602, 604, and 606 can be cut using a tool with a profile having two substantially parallel edges and a substantially perpendicular edge, for example the profile 610. Edge 608 can be cut using a tool with a profile having an arcuate edge, for example the profile 612.

At step 410, once all cutting has been completed, a frame is formed from the sheet of metal. The sheet of metal may be folded, rolled, swaged, and/or bent into a frame, which may be a substantially C-channel frame or a substantially U-channel frame. The gauge of the frame may range from 0.4 mm to 3.2 mm.

At step 412 after the frame has been formed, the end portion of the frame formed at step 410 is pressed inwards such that its width is reduced compared to the middle portion. The height of the end portion may also be reduced. The end portion of the frame is pressed to form the structure of described above comprising the base 218, the walls 220, and the shoulders 216. This may be done by deforming the end portion to the shape of a preformed or die. This step may require multiple pressing operations.

A middle portion of the end portion of the frame may be pressed downwards to a depth less than or equal to the height of the arm 214. This forms the base 218 which is recessed relative to the shoulders 216. Formation of the walls 220 necessarily reduces the width of the end portion to account for the change in elevation.

Pressing may comprise stamping and swaging.

At step 414, one or more apertures are cut so that the joining member may receive one or more fasteners (e.g. fastener 211) in use.

### Method 2

FIG. 5 describes a method 500 for manufacturing a joining member. The method 500 uses a C-channel steel frame as a starting point. The C-channel steel frame may be the same steel frame as that used for the top and bottom chords in a truss. The type of steel may be cold-formed steel (CFS) or light gauge steel (LGS). The gauge of the C-channel steel frame may range from 0.4 mm to 3.2 mm.

At step 502, a C-channel steel frame is cut along its height at a first longitudinal position in an end portion. This may form the cutting edge 228.1 or the cutting edge 228.3. If the cutting edge is 228.3, then preferably there is a longitudinal separation of at least 20% of the width of the C-channel steel frame between the first longitudinal position and the proximate longitudinal end of the C-channel steel frame. If the cutting edge is 228.1, then preferably there is a longitudinal separation of at least 70% of the width of the C-channel steel frame between the first longitudinal position and the proximate longitudinal end of the C-channel steel frame.

At step 504, the C-channel steel frame is cut along its length from the first longitudinal position to a second longitudinal position in the same end portion. This forms the cutting edge 228.2. As explained above, this cut preferably has a length of at least 50% of the width of the C-channel steel frame.

At step 506, the C-channel steel frame is cut along its height at the second longitudinal position in the same end portion. If the cutting edge of step 502 is 228.1, then this cut forms the cutting edge 228.3. If the cutting edge of step 502 is 228.3, then this cut forms the cutting edge 228.1.

Optionally at step 507, the C-channel steel frame is accurately cut to form a curved edge in the same end portion, which forms the rounded tip portion 222.

Cutting may comprise stamping, punching, and blanking.

At step 508, the end portion of the C-channel steel frame is pressed inwards such that its width is reduced compared to the middle portion. The end portion of the frame is pressed to form the structure described above comprising the base 218, the walls 220, and the shoulders 216. This may be done by deforming the end portion to the shape of a preformed or die. This step may require multiple pressing operations.

A middle portion of the end portion of the frame may be pressed downwards to a depth less than or equal to the height of the arm 214. This forms the base 218 which is recessed relative to the shoulders 216. Formation of the walls 220 necessarily reduces the width of the end portion to account for the change in height.

Pressing may comprise stamping and swaging.

Optionally at step 509, one or more apertures are punched so that the joining member

may receive one or more fasteners (e.g. fastener 211) in use. Alternatively, the frame may already have a preformed aperture at an end portion before any of the above steps are performed.

At step 510, the steps 502, 504, 506, 507, 508 and 509 are performed for the other end portion of the frame. A joining member is formed after step 510. As explained above, the joining member may or may not comprise a middle portion.

### Interpretation

A number of methods have been described above. Any of these methods may be embodied in a series of instructions, which may form a computer program. These instructions, or this computer program, may be stored on a computer readable medium, which may be non-transitory. When executed, these instructions or this program cause a processor to perform the described methods.

Where a feature is referred to as xxx but the label xxx is not present in a drawing, xxx refers generally to all subspecies (e.g. xxx.1, xxx.2, xxx.3, etc.) of the xxx class. That is, any difference between xxx.y and xxx.z is not important in the context where xxx is used in general terms.

The steps of the methods have been described in a particular order for ease of understanding. However, the steps can be performed in a different order from that specified, or with steps being performed in parallel. This is the case in all methods except where one step is dependent on another having been performed.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1. A truss, comprising:
a first truss member;
a second truss member; and
a third truss member configured to join the first truss member to the second truss member;
wherein the third truss member comprises an end portion comprising:
a flat base;
an arm; and
a shoulder raised relative to the flat_base between the flat_base and the arm;
wherein the shoulder is substantially parallel to the flat base,
wherein the flat base engages substantially flush with a surface of the first truss member at a contact surface.

2-10. (canceled)

11. The truss of claim 1, wherein the flat base engages substantially flush with a surface of the second truss member at a contact surface and wherein a length of the contact surface is at least 50% of the width of the first truss member or the width of the second truss member, the length being a longitudinal dimension.

12. (canceled)

13. The truss of claim 1, wherein the third truss member further comprises a middle portion and a second end portion, wherein the middle portion adjoins the end portion and the second end portion and wherein the first end portion and a second end portion have reduced height compared to the middle portion, the height being a vertical dimension.

14. (canceled)

15. The truss of claim 13, wherein the flat base is pressed inwards to a depth relative to an outer surface of the middle portion, the depth being less than or equal to a height of the arm, the height being a vertical dimension.

16. The truss of claim 13, wherein the end portion further comprises a second shoulder, a second wall, and a second arm, wherein the second arm adjoins the flat base and the second shoulder such that the flat base is disposed between the shoulder and the second shoulder.

17. The truss of claim 13, wherein the second end portion comprises a flat base, a first shoulder and a second shoulder, a first arm and a second arm, and a first wall and a second wall.

18. (canceled)

19. (canceled)

20. The truss of claim 1, wherein the first and second truss members are chords.

21. The truss of claim 20, wherein the third truss member is a web.

22-24. (canceled)

25. A truss member comprising an end portion, the end portion comprising:
a flat base;
an arm; and
a shoulder raised relative to the flat base between the flat base and the arm;
wherein the shoulder is substantially parallel to the flat base, wherein the flat base engages substantially flush with a surface of the first truss member at a contact surface.

26. A method for manufacturing a truss member, comprising:
cutting a sheet of steel in a first direction at a first position;
cutting the sheet of steel in a second direction that is substantially perpendicular to the first direction;
cutting the sheet of steel in a third direction that is substantially parallel to the first direction at a second position different from the first position;
forming the sheet of metal into a substantially C-channel frame; and
reducing a width of an end portion of the steel frame, the width being a lateral dimension.

27. The method of claim 26, further comprising cutting a curved edge in the sheet of steel.

28. The method of claim 27, further comprising punching one or more apertures in the sheet of steel.

29. The method of claim 26, wherein reducing the width of the end portion of the steel frame comprises pressing the end portion of the steel frame inwards.

30. The method of claim 26, further comprising reducing a height of the end portion of the steel frame.

31-33. (Cancelled)

34. A method for manufacturing a truss member, comprising:
cutting an end portion of a steel frame along its height at a first longitudinal position;
cutting the end portion of the steel frame along its length to a second longitudinal position;
cutting the end portion of the steel frame along its height at the second longitudinal position; and
reducing a width of the end portion of the steel frame, the width being a lateral dimension.

35. The method of claim 34, further comprising cutting a curved edge in the end portion of the steel frame.

36. The method of claim 34, further comprising punching one or more apertures in the steel frame.

37. The method of claim 34, wherein reducing the width of the end portion of the steel frame comprises pressing the end portion of the steel frame inwards.

38. The method of claim 34, further comprising reducing a height of the end portion of the steel frame, the height being a vertical dimension.

39. The method of claim 34, wherein the steel frame is a substantially C-channel steel frame.

40-42. (Cancelled)
